(19) United States
(12) Patent Application Publication
(10) Pub. No.: US 2026/0038203 A1
(43) Pub. Date: Feb. 5, 2026

(54) GENERATION AND TRAVERSAL OF CONSERVATIVE LOW-RESOLUTION BOUNDING VOLUME HIERARCHY

(71) Applicant: QUALCOMM Incorporated, San Diego, CA (US)

(72) Inventors: Alfredo Olegario SAUCEDO, San Diego, CA (US); Adimulam RAMESH BABU, San Diego, CA (US); Srihari Babu ALLA, San Diego, CA (US)

(21) Appl. No.: 18/791,276

(22) Filed: Jul. 31, 2024

(51) Int. Cl. G06T 17/00; G06T 15/06

(52) U.S. Cl. CPC G06T 17/005; G06T 15/06; G06T 2210/21

(57) ABSTRACT

This disclosure provides systems, devices, apparatus, and methods, including computer programs encoded on storage media, for traversing a low-resolution BVH. A processor may obtain a first indication of a low-resolution BVH that includes a set of conservative candidate nodes that are associated with corresponding internal nodes of a full-resolution BVH. The processor may traverse the low-resolution BVH by (a) determining whether a ray intersects a primitive leaf of a conservative candidate node of the set of conservative candidate nodes in response to a first determination that the ray intersects the conservative candidate node and (b) traversing an internal node of the full-resolution BVH that corresponds with the conservative candidate node in response to a second determination that the ray does not intersect the primitive leaf. The processor may output a second indication of a ray trace hit or a ray trace miss based the traversal.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for ray traversal may be costly to perform. There is a need for improved ray tracing techniques that reduce the cost of ray traversal.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and a processor coupled to the memory and, based on information stored in the memory, the processor may be configured to obtain a first indication of a low-resolution bounding volume hierarchy (BVH). The low-resolution BVH may include a set of conservative candidate nodes that are associated with corresponding internal nodes of a full-resolution BVH. The processor may be configured to traverse the low-resolution BVH by (a) determining whether a ray intersects a primitive leaf of a conservative candidate node of the set of conservative candidate nodes in response to a first determination that the ray intersects the conservative candidate node and (b) traversing an internal node of the full-resolution BVH that corresponds with the conservative candidate node in response to a second determination that the ray does not intersect the primitive leaf. The processor may be configured to output a second indication of a ray trace hit or a ray trace miss based on at least one of a third determination that the ray intersects the primitive leaf of the conservative candidate node or a traversal of the internal node of the full-resolution BVH that corresponds with the conservative candidate node.

In some aspects, the techniques described herein relate to a method of graphics processing, including: obtaining a first indication of a low-resolution bounding volume hierarchy (BVH) including a set of conservative candidate nodes that are associated with corresponding internal nodes of a full-resolution BVH; traversing the low-resolution BVH by: determining whether a ray intersects a primitive leaf of a conservative candidate node of the set of conservative candidate nodes in response to a first determination that the ray intersects the conservative candidate node; and traversing an internal node of the full-resolution BVH that corresponds with the conservative candidate node in response to a second determination that the ray does not intersect the primitive leaf; and outputting a second indication of a ray trace hit or a ray trace miss based on at least one of a third determination that the ray intersects the primitive leaf of the conservative candidate node or a traversal of the internal node of the full-resolution BVH that corresponds with the conservative candidate node.

In some aspects, the techniques described herein relate to a method, where the conservative candidate node includes a first set of primitive leaves and is associated with an axis-aligned bounding box (AABB) that bounds a second set of primitive leaves, where the first set of primitive leaves is a subset of the second set of primitive leaves, where the internal node of the full-resolution BVH that corresponds with the conservative candidate node includes a third set of child primitive leaves including the second set of primitive leaves.

In some aspects, the techniques described herein relate to a method, further including: traversing the low-resolution BVH by at least one of: traversing a second internal node of the low-resolution BVH; or traversing the conservative candidate node of the set of conservative candidate nodes in response to a fourth determination that the ray intersects the second internal node of the low-resolution BVH; and outputting a third indication of a second ray trace hit or a second ray trace miss based on at least one of a fifth determination that the ray does not intersect the second internal node of the low-resolution BVH, or a sixth determination that the ray does not intersect the conservative candidate node.

In some aspects, the techniques described herein relate to a method, further including: determining whether a second traversal of the ray intersects on a first hit; and traversing the internal node of the full-resolution BVH that corresponds with the conservative candidate node in response to a fourth determination that the traversal of the ray does not end on the first hit wherein the ray intersects the primitive leaf.

In some aspects, the techniques described herein relate to a method, where a first ray trace miss of any of the set of conservative candidate nodes of the low-resolution BVH corresponds with a second ray trace miss of every internal node of the full-resolution BVH.

In some aspects, the techniques described herein relate to a method, where a first ray trace miss of any internal node of the low-resolution BVH corresponds with a second ray trace miss of every internal node of the full-resolution BVH.

In some aspects, the techniques described herein relate to a method, where the internal node of the full-resolution BVH that corresponds with the conservative candidate node includes a set of child primitives that are constrained by an axis-aligned bounding box (AABB) of the conservative candidate node.

In an aspect of the disclosure, a method, a computer-readable medium, and an apparatus are provided. The apparatus includes a memory; and a processor coupled to the memory and, based on information stored in the memory, the processor may be configured to obtain a first indication of a full-resolution bounding volume hierarchy (BVH). The full-resolution BVH may include a set of primitives. The processor may be configured to obtain a set of primitive clusters and a set of representative primitives. Each of the set of primitive clusters may be associated with a representative primitive of the set of representative primitives. Each primitive of the set of primitive clusters may include a primitive from the set of primitives. The processor may be configured to generate a low-resolution BVH based on the set of representative primitives. The processor may be configured to assign an axis-aligned bounding box (AABB) to each conservative internal node associated with each representative primitive of the set of representative primitives based on a corresponding primitive cluster of the set of primitive clusters. The processor may be configured to associate each conservative internal node of the low-resolution BVH to a corresponding internal node of the full-resolution BVH based on the corresponding primitive cluster of the set of primitive clusters. The processor may be configured to output a second indication of the low-resolution BVH and a third indication of an association of each conservative internal node of the low-resolution BVH to the corresponding internal node of the full-resolution BVH.

In some aspects, the techniques described herein relate to a method of graphics processing, including: obtaining a first indication of a full-resolution bounding volume hierarchy (BVH) including a set of primitives; obtaining a set of primitive clusters and a set of representative primitives, where each of the set of primitive clusters is associated with a representative primitive of the set of representative primitives, where each primitive of the set of primitive clusters includes a primitive from the set of primitives; generating a low-resolution BVH based on the set of representative primitives; assigning an axis-aligned bounding box (AABB) to each conservative internal node associated with each representative primitive of the set of representative primitives based on a corresponding primitive cluster of the set of primitive clusters; associating each conservative internal node of the low-resolution BVH to a corresponding internal node of the full-resolution BVH based on the corresponding primitive cluster of the set of primitive clusters; and outputting a second indication of the low-resolution BVH and a third indication of an association of each conservative internal node of the low-resolution BVH to the corresponding internal node of the full-resolution BVH.

In some aspects, the techniques described herein relate to a method, where assigning the AABB to each conservative internal node associated with the representative primitive based on the corresponding primitive cluster of the set of primitive clusters includes: assigning the AABB to each conservative internal node such that the assigned AABB encompasses each primitive of the corresponding primitive cluster.

In some aspects, the techniques described herein relate to a method, further including: obtaining a fourth indication of a space-fit sorted array of the set of primitives; clustering adjacent primitives of the space-fit sorted array into the set of primitive clusters; and selecting the representative primitive for each primitive cluster of the set of primitive clusters.

In some aspects, the techniques described herein relate to a method, where obtaining the second indication of the space-fit sorted array of the set of primitives includes: sorting the set of primitives based on a Morton space-filling curve.

In some aspects, the techniques described herein relate to a method, where selecting the representative primitive for each primitive cluster of the set of primitive clusters includes: selecting the representative primitive based on a largest comparative diagonal size.

In some aspects, the techniques described herein relate to a method, where the corresponding internal node of the full-resolution BVH that corresponds with each conservative candidate node includes a set of child primitives that are constrained by an AABB of the conservative candidate node.

In some aspects, the techniques described herein relate to a method, where the third indication of the association of each conservative internal node of the low-resolution BVH to the corresponding internal node of the full-resolution BVH includes an index including a first set of identifiers for a set of conservative internal nodes of the low-resolution BVH and a second set of identifiers for a set of corresponding internal nodes of the full-resolution BVH.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3 is a diagram illustrating an example ray tracing process in accordance with one or more techniques of this disclosure.

FIG. 4A is a diagram illustrating an example rasterization process in accordance with one or more techniques of this disclosure.

FIG. 4B is a diagram illustrating an example ray tracing process in accordance with one or more techniques of this disclosure.

FIG. 5 is a diagram illustrating an example ray tracing process in accordance with one or more techniques of this disclosure.

FIG. 6A is a diagram illustrating an example data structure in accordance with one or more techniques of this disclosure.

FIG. 6B is a diagram illustrating an example data structure in accordance with one or more techniques of this disclosure.

FIG. 7A is a diagram illustrating an example bounding volume hierarchy (BVH) in accordance with one or more techniques of this disclosure.

FIG. 7B is a diagram illustrating another example BVH in accordance with one or more techniques of this disclosure.

FIG. 8A is a diagram illustrating an example of a series of stages that may be used to generate a full-resolution BVH in accordance with one or more techniques of this disclosure.

FIG. 8B is a diagram illustrating an example of a full-resolution BVH generated using the series of stages in FIG. 8A in accordance with one or more techniques of this disclosure.

FIG. 9A is a diagram illustrating an example of a series of stages that may be used to generate a low-resolution BVH in accordance with one or more techniques of this disclosure.

FIG. 9B is a diagram illustrating an example of a low-resolution BVH generated using the series of stages in FIG. 8A in accordance with one or more techniques of this disclosure.

FIG. 9C is a diagram illustrating an example of a low-resolution to high-resolution map for the low-resolution BVH of FIG. 9B and the full-resolution BVH of FIG. 8B in accordance with one or more techniques of this disclosure.

FIG. 10 is a diagram illustrating an example method of generating a low-resolution BVH in accordance with one or more techniques of this disclosure.

FIG. 11 is a diagram illustrating an example method of traversing a full-resolution BVH in accordance with one or more techniques of this disclosure.

FIG. 12 is a diagram illustrating an example method of traversing a low-resolution BVH in accordance with one or more techniques of this disclosure.

FIG. 13 is a call flow diagram illustrating example communications between a BVH-building component and a BVH-traversing component in accordance with one or more techniques of this disclosure.

FIG. 14 is a flowchart of an example method of graphics processing in accordance with one or more techniques of this disclosure.

FIG. 15 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

Ray tracing may refer to a technique for generating an image by tracing a path of light as the light bounces off an object. Ray tracing may be utilized to produce realistic lighting effects in various applications, including video game applications. Ray tracing may refer to a graphical rendering technique that simulates the physical behavior of light. Ray tracing may offer increased graphical realism in comparison to other graphical rendering techniques (e.g., rasterization). However, the increased graphical realism may be associated with increased computational complexity in comparison to other graphical rendering techniques. Ray tracing may involve determining an intersection between a ray (i.e., a line having a direction that extends from a point) and a primitive (i.e., a simplest geometric shape that a system is able to draw, such as a triangle). Determining the intersection may be a computationally complex process. A graphics processor may utilize an acceleration structure in order to reduce computational complexity of ray tracing. An acceleration structure may refer to a data structure that aids a processor (e.g., GPU, a CPU) in identifying objects in a scene that a ray is likely to intersect and objects in the scene that the ray is not likely to intersect. In an example, an acceleration structure may include a bounding volume hierarchy (BVH).

A BVH, or a BVH tree, may refer to a tree structure for a set of geometric objects. The set of geometric objects may include leaf nodes of the tree wrapped in bounding volumes. The leaf nodes may be grouped as small sets (e.g., subsets) and may be enclosed within larger bounding volumes that enclose the child small sets which are in turn grouped and enclosed within other larger bounding volumes that also enclose the child leaf nodes in a recursive manner, resulting in a tree structure with a single bounding volume as a root node of the tree that encloses all child leaf nodes in the BVH. In other words, the BVH may be a tree structure on a set of geometric objects that are each recursively wrapped in bounding volumes until the entire set of geometric objects is wrapped in a single bounding volume. In some aspects, a BVH may directly include primitives themselves in the leaf nodes of the BVH. In other aspects, a BVH may include an indicator to a primitive (e.g., a memory address, a link) in the leaf nodes of the BVH. A traversal of the BVH may be referred to as a BVH traversal or a ray trace.

During a BVH traversal with respect to a ray, a recursive loop may run until a primitive is hit, or a primitive/internal node is missed, which ends the traversal. As such, at a compile time, an upper limit of a number of iterations of the BVH traversal may not be known. As used herein, a compile time may refer to a period of time at which instructions are compiled (or prepared to be compiled) into machine-readable instructions. As used herein, a loop may refer to a control flow statement that specifies or is associated with an iteration. Loops may include for loops and while loops. A loop may include a specified or an unspecified number of iterations. A loop may be utilized to avoid duplication(s) of instructions.

In some aspects, a BVH traversal cost may be a function of the number of nodes in the BVH. Thus, a reduction in the total number of BVH nodes in a BVH may lead to a proportional increase in traversal performance. In some aspects, a processor (e.g., a CPU, a GPU) may generate a low-resolution BVH based on primitives of a full-resolution BVH. A low-resolution BVH may include a subset of the primitives contained in a corresponding full-resolution BVH. The processor may obtain a first indication of a full-resolution BVH. The full-resolution BVH may include a set of primitives. The processor may be configured to obtain a set of primitive clusters and a set of representative primitives. A set of primitive clusters may be a set of primitives that area associated with one another, for example primitives that are adjacent to one another. Each of the set of primitive clusters may be associated with a representative primitive of the set of representative primitives. In other words, the representative primitive may represent a primitive cluster. Each primitive of the set of primitive clusters may include a primitive from the set of primitives used to construct a full-resolution BVH. In other words, the set of representative primitives in the low-resolution BVH is a subset, or a strict subset, of the set of primitives used to construct the full-resolution BVH. In some aspects, the sum total of primitives from the set of primitives may equal the sum total of primitives from the set of primitive clusters. Each primitive cluster may be associated with a plurality of primitives (i.e., cluster of primitives) from the set of primitives of a full-BVH. One representative primitive from each primitive cluster set may be selected for each cluster to construct the set of representative primitives.

The processor may be configured to generate a low-resolution BVH based on the set of representative primitives. The processor may be configured to assign an axis-aligned bounding box (AABB) to each conservative internal node associated with each representative primitive of the set of representative primitives based on a corresponding primitive cluster of the set of primitive clusters. The processor may be configured to associate each conservative internal node of the low-resolution BVH to a corresponding internal node of the full-resolution BVH based on the corresponding primitive cluster of the set of primitive clusters. A conservative internal node may be an internal node that does not have any children other than primitive leaves. In other words, a conservative internal node may not have another internal node as a child. The processor may be configured to output a second indication of the low-resolution BVH and a third indication of an association of each conservative internal node of the low-resolution BVH to the corresponding internal node of the full-resolution BVH. In such a low-resolution BVH, BVH traversal would not be lossy. In other words, bounding volume information about the full set of primaries would not be lost even if a conservative node does not include the full set of primary child leaves.

In some aspects, a processor (e.g., a CPU, a GPU) may traverse a low-resolution BVH and a corresponding full-resolution BVH based on a map that correlates conservative internal nodes of the low-resolution BVH with corresponding internal nodes of the full-resolution BVH. The processor may obtain a first indication of a low-resolution BVH. The low-resolution BVH may include a set of conservative candidate nodes that are associated with corresponding internal nodes of a full-resolution BVH. The processor may be configured to traverse the low-resolution BVH by (a) determining whether a ray intersects a primitive leaf of a conservative candidate node of the set of conservative candidate nodes in response to a first determination that the ray intersects the conservative candidate node and (b) traversing an internal node of the full-resolution BVH that corresponds with the conservative candidate node in response to a second determination that the ray does not intersect the primitive leaf. The processor may be configured to output a second indication of a ray trace hit or a ray trace miss based on at least one of a third determination that the ray intersects the primitive leaf of the conservative candidate node or a traversal of the internal node of the full-resolution BVH that corresponds with the conservative candidate node.

In some aspects, a BVH system may generate a low-resolution BVH along with a full-resolution BVH. A low-resolution BVH may also be referred to as a sparse-BVH, or a sparse-BVH tree. A full-resolution BVH may also be referred to as a full-BVH, or a full-BVH tree. The low-resolution BVH may be embedded with the special properties such that ray trace misses are valid ray misses in the full-resolution BVH, candidate intersections in the low-resolution BVH are valid candidate intersections in the full-resolution BVH, and leaf nodes of the low-resolution BVH hold the set of primitives (S2) that is a subset of the set of all primitives (S1) used to build the full-resolution BVH (S2 [symbol] S1).

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

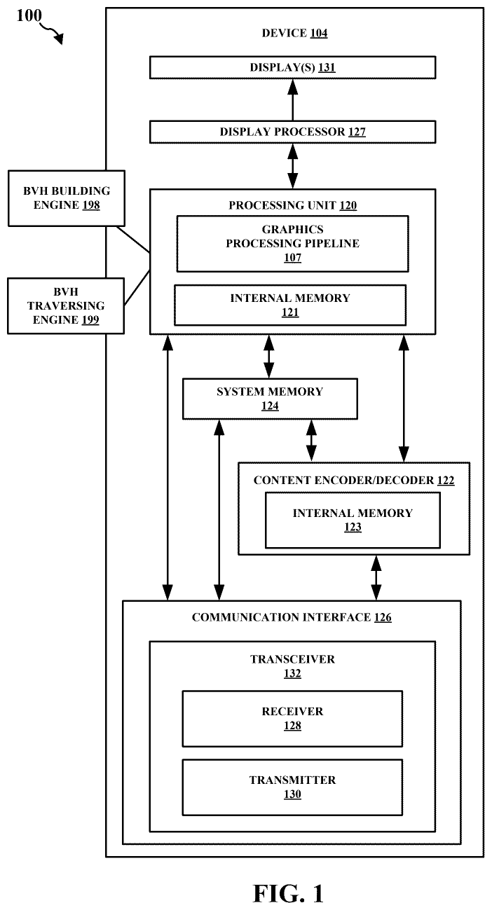

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a BVH building engine 198 configured to obtain a first indication of a full-resolution BVH. The full-resolution BVH may include a set of primitives. The processor may be configured to obtain a set of primitive clusters and a set of representative primitives. Each of the set of primitive clusters may be associated with a representative primitive of the set of representative primitives. Each primitive of the set of primitive clusters may include a primitive from the set of primitives. The processor may be configured to generate a low-resolution BVH based on the set of representative primitives. The processor may be configured to assign an AABB to each conservative internal node associated with each representative primitive of the set of representative primitives based on a corresponding primitive cluster of the set of primitive clusters. The processor may be configured to associate each conservative internal node of the low-resolution BVH to a corresponding internal node of the full-resolution BVH based on the corresponding primitive cluster of the set of primitive clusters. The processor may be configured to output a second indication of the low-resolution BVH and a third indication of an association of each conservative internal node of the low-resolution BVH to the corresponding internal node of the full-resolution BVH.

In certain aspects, the processing unit 120 may include a BVH traversing engine 199 configured to obtain a first indication of a low-resolution BVH. The low-resolution BVH may include a set of conservative candidate nodes that are associated with corresponding internal nodes of a full-resolution BVH. The processor may be configured to traverse the low-resolution BVH by (a) determining whether a ray intersects a primitive leaf of a conservative candidate node of the set of conservative candidate nodes in response to a first determination that the ray intersects the conservative candidate node and (b) traversing an internal node of the full-resolution BVH that corresponds with the conservative candidate node in response to a second determination that the ray does not intersect the primitive leaf. The processor may be configured to output a second indication of a ray trace hit or a ray trace miss based on at least one of a third determination that the ray intersects the primitive leaf of the conservative candidate node or a traversal of the internal node of the full-resolution BVH that corresponds with the conservative candidate node.

Although the following description may be focused on graphics processing, the concepts described herein may be applicable to other similar processing techniques. Furthermore, although the following description may be focused on ray tracing, the concepts presented herein may also be applicable to other types of tracing as well (e.g., path tracing).

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

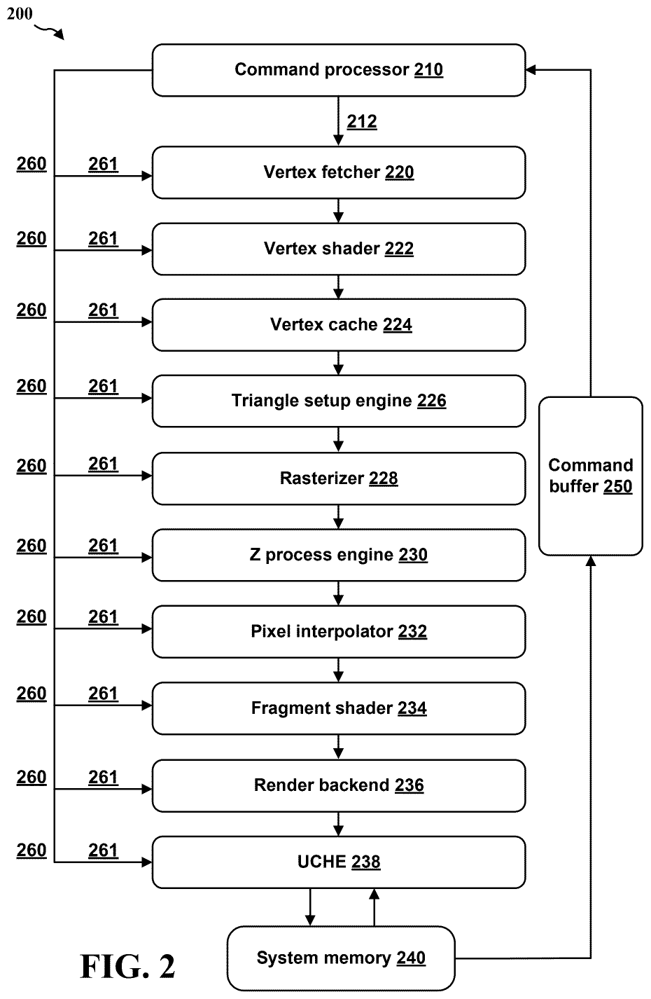

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

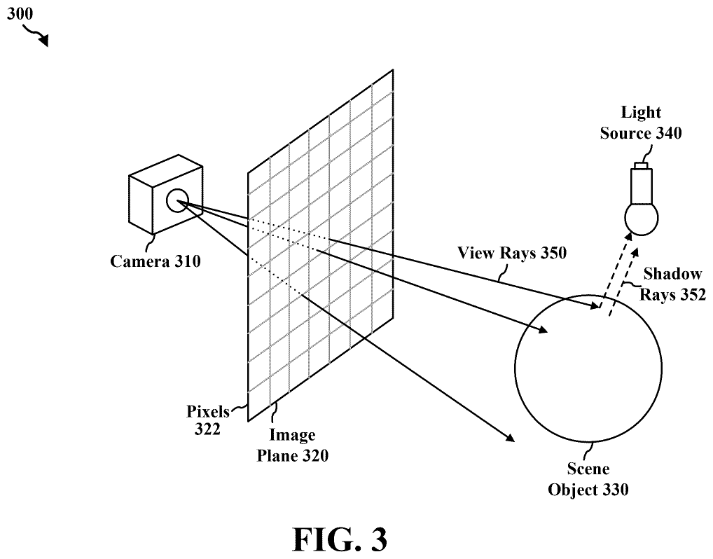

FIG. 3 illustrates diagram 300 including one example of a ray tracing process. As shown in FIG. 3, diagram 300 includes camera 310, image plane 320 including pixels 322, scene object 330, light source 340, view rays 350, and shadow rays 352. FIG. 3 shows that view rays 350 are traced from camera 310 and through image plane 320. After passing image plane 320, the view rays 350 are traced to scene object 330. At least some of the view rays 350 are traced off of scene object 330 and are traced towards light source 340 as shadow rays 352. Accordingly, the shadow rays 352 and view rays 350 may trace the light from light source 340. FIG. 3 depicts how ray tracing may generate an image by tracing the path of light (e.g., from light source 340) for the pixels in an image plane (e.g., pixels 322 in image plane 320).

Ray tracing is distinguishable from a number of other rendering techniques utilized in graphics processing, such as rasterization. In the process of rasterization, for each pixel in each primitive in a scene, the pixel may be shaded if a portion of the pixel is covered by the primitive. In contrast, in the process of ray tracing, for each pixel corresponding to a primitive in a scene, a ray is generated. If the generated ray is determined to hit or strike a certain primitive, then the pixel is shaded. In some instances of graphics processing, ray tracing algorithms may be performed alongside rasterization, such as via a hybrid ray tracing/rasterization model.

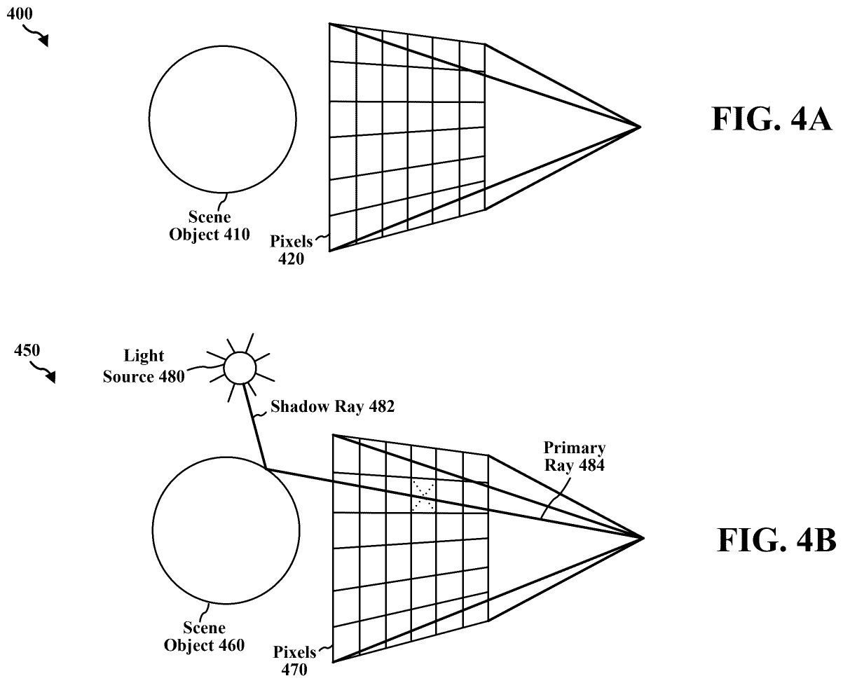

FIG. 4A and FIG. 4B illustrate a diagram 400 and a diagram 450 including an example process of rasterization and an example process of ray tracing, respectively. As shown in FIG. 4A, diagram 400 includes scene object 410 and pixels 420. FIG. 4A depicts that the process of rasterization determines, for each of pixels 420 in a scene including scene object 410, a pixel is shaded if a portion of the pixel is covered by a primitive. As shown in FIG. 4B, diagram 450 includes scene object 460, pixels 470, light source 480, shadow ray 482, and primary ray 484. FIG. 4B depicts that the process of ray tracing determines if a generated ray (e.g., shadow ray 482) will hit or strike a certain primitive in scene object 460 corresponding to one of the pixels 470 via primary ray 484, then the pixel is shaded.

As indicated herein, the process of ray tracing may be performed by determining whether a ray will hit/strike any primitive(s) in a scene. For example, ray tracing algorithms may perform a simple query operation to determine whether a given ray going to hit/strike any primitive(s) in a scene. The process of ray tracing may be computationally intensive, as a large number of rays may be traced against a large number of primitives/triangles, which may utilize a large number of ray-triangle intersection tests. For example, in one ray tracing procedure, approximately 1 million rays may be traced against approximately 1 million primitives/triangles, which may utilize approximately 1 trillion ray-triangle intersection tests. In some aspects of ray tracing procedures, an origin point for a given ray may be represented by O(N). Further, there may be a number of values calculated for the ray, such as a minimum time to strike primitives in a scene (tₘᵢₙ), a maximum time to strike primitives in a scene (tₘₐₓ), and a calculated distance to strike primitives in the scene.

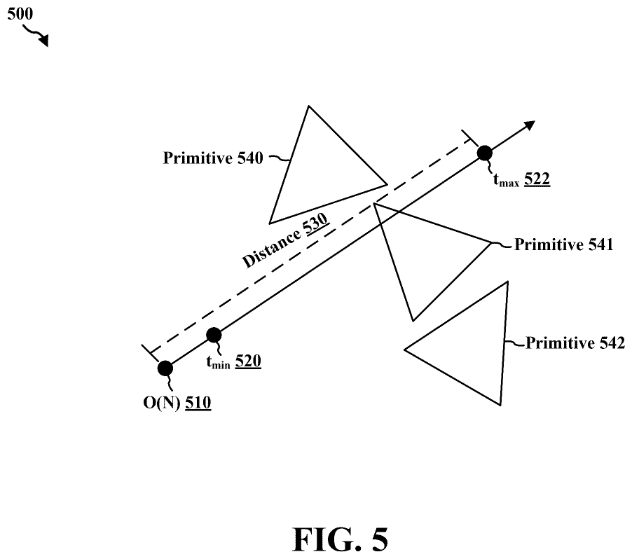

FIG. 5 illustrates a diagram 500 including one example of a ray tracing process. As shown in FIG. 5, the diagram 500 includes origin point for a ray (O(N) 510), a minimum time to strike primitives in a scene (tₘᵢₙ 520), a maximum time to strike primitives in a scene (tₘₐₓ 522), a calculated distance to strike primitives in the scene (distance 530), and a number of primitives (primitive 540, primitive 541, and primitive 542) in the scene. FIG. 5 shows that ray tracing techniques may utilize a number of values to determine if a ray is going to hit a primitive. For instance, to determine if a ray will strike a primitive, ray tracing techniques may utilize an origin point for a ray (O(N) 510), a minimum time to strike primitives (tₘᵢₙ 520), a maximum time to strike primitives (tₘₐₓ 522), a calculated distance to strike primitives (distance 530), and a number of primitives (primitive 540, primitive 541, and primitive 542).

Ray tracing may utilize various data structures for accelerating a computational process, such as a bounding volume hierarchy (BVH). In a bounding volume hierarchy, primitives are held in leaf nodes. Further, internal nodes may hold access aligned bounding boxes (AABBs) that enclose certain leaf node geometry. Data structures for ray tracing may also utilize a ray-box intersection for internal nodes and/or a ray-triangle test for leaf nodes. These types of data structures may reduce the computational complexity (N) of the ray tracing process, e.g., reduce the computational complexity (N) by log (N).

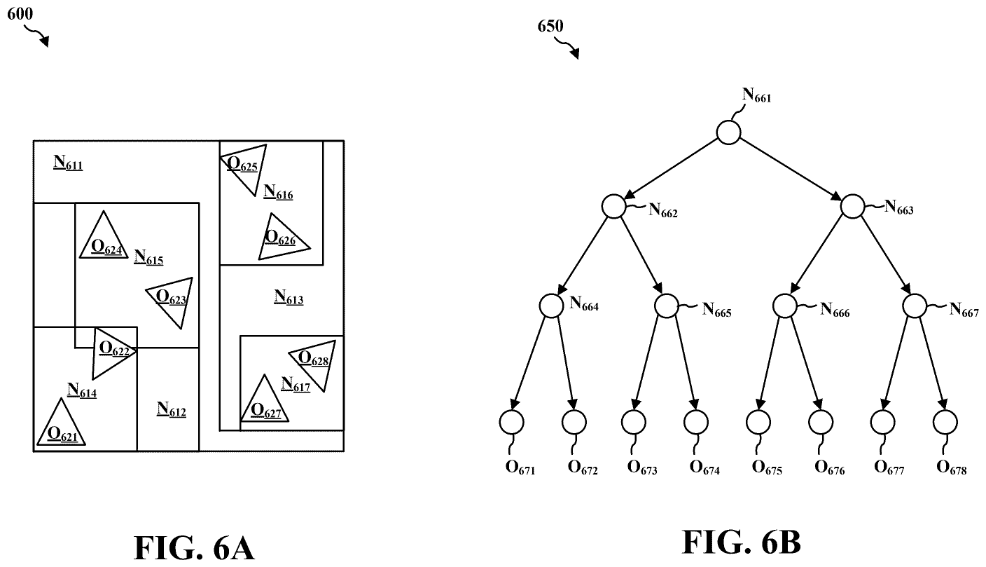

FIG. 6A and FIG. 6B illustrate a diagram 600 and a diagram 650, respectively, including example data structure techniques utilized in ray tracing. As shown in FIG. 6A, diagram 600 includes a number of nodes (internal nodes N₆₁₁-N₆₁₇) and a number of primitives (primitives O₆₂₁-O₆₂₈). FIG. 6A depicts a ray-box intersection for internal nodes N₆₁₁-N₆₁₇ and primitives O₆₂₁-O₆₂₈. As shown in FIG. 6B, diagram 650 includes a number of nodes (leaf nodes N₆₆₁-N₆₆₇) and a number of primitives (primitives O₆₇₁-O₆₇₈). FIG. 6B depicts a ray-triangle test for leaf nodes N₆₆₁-N₆₆₇ and primitives O₆₇₁-O₆₇₈. Both of the data structure techniques in FIGS. 6A and 6B, e.g., the ray-box intersection and the ray-triangle test, aim to reduce the computational complexity in ray tracing.

As indicated herein, there are a number of different stages during a ray tracing process. For example, the stages of ray tracing may include: bounding volume hierarchy construction and refinement, ray generation, bounding volume hierarchy traversal, ray-triangle intersection, and ray-box intersection. There may also be different steps during bounding volume hierarchy construction, including partitioning triangles into multiple groups, forming a bounding box around each group, and recursively partitioning each group. Additionally, there may be several ways to partition during bounding volume hierarchy construction, which may result in a certain number of possible solutions, e.g., 2^{n log n} solutions. As a result, these improved solutions may yield improved ray tracing performance.

Aspects of ray tracing may also utilize a number of bounding volume hierarchy algorithms, such as split bounding volume hierarchy (SBVH) and linear bounding volume hierarchy (LBVH). In some instances, SBVH may result in slower build times and better quality compared to LBVH. Likewise, LBVH may result in faster build times and poorer quality compared to SBVH. Additionally, some aspects of ray tracing may utilize bounding volume hierarchy refinement. In bounding volume hierarchy refinement, given a binary BVH with one triangle per leaf, ray tracing techniques may permute the tree topology. Bounding volume hierarchy refinement may utilize different algorithms, e.g., a treelet restructuring BVH (TRBVH) and a parallel reinsertion BVH (PRBVH). Some aspects of ray tracing may also utilize BVH widening, which may convert a binary tree (i.e., an initial BVH) to a wide BVH that is wider than the binary tree or initial BVH. For example, hierarchy in the initial BVH may include three levels, where the primitives are included in a third level of the hierarchy. The hierarchy in the wide BVH may include two levels, where the primitives are included in a second level of the hierarchy. In some instances of BVH widening, the wide BVH may include an internal node with a certain amount of AABBs (e.g., up to eight AABBs) and a leaf node with a certain number of primitives/triangles (e.g., up to four primitives/triangles).

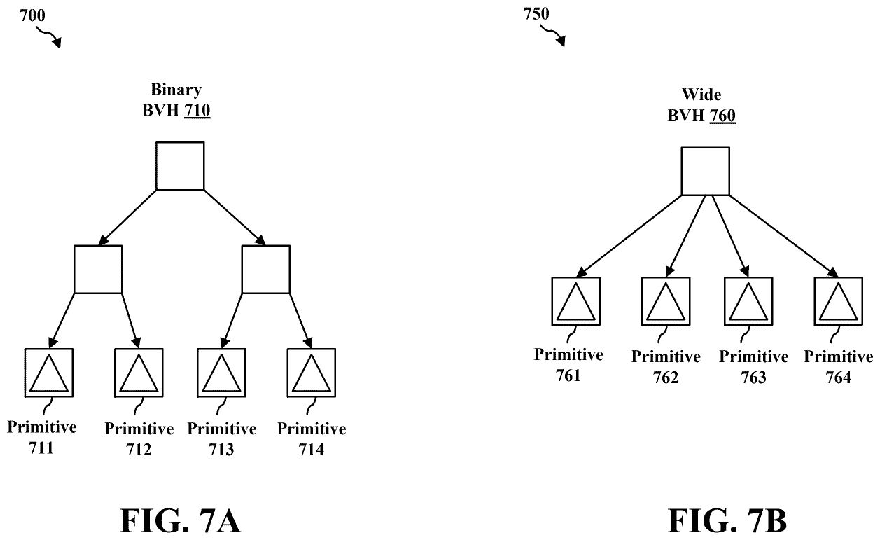

FIG. 7A and FIG. 7B illustrate a diagram 700 and a diagram 750 including a binary bounding volume hierarchy and a wide bounding volume hierarchy, respectively. As shown in FIG. 7A, diagram 700 includes a binary bounding volume hierarchy 710 including primitive 711, primitive 712, primitive 713, and primitive 714. FIG. 7A depicts that binary bounding volume hierarchy 710 includes three levels, where primitives 711-714 are in the third level of the hierarchy. As shown in FIG. 7B, diagram 750 includes a wide bounding volume hierarchy 760 including primitive 761, primitive 762, primitive 763, and primitive 764. FIG. 7B depicts that wide bounding volume hierarchy 760 includes two levels, where primitives 761-764 are in the second level of the hierarchy. As shown in FIGS. 7A and 7B, binary bounding volume hierarchy 710 may undergo a process of bounding volume hierarchy widening that results in wide bounding volume hierarchy 760.

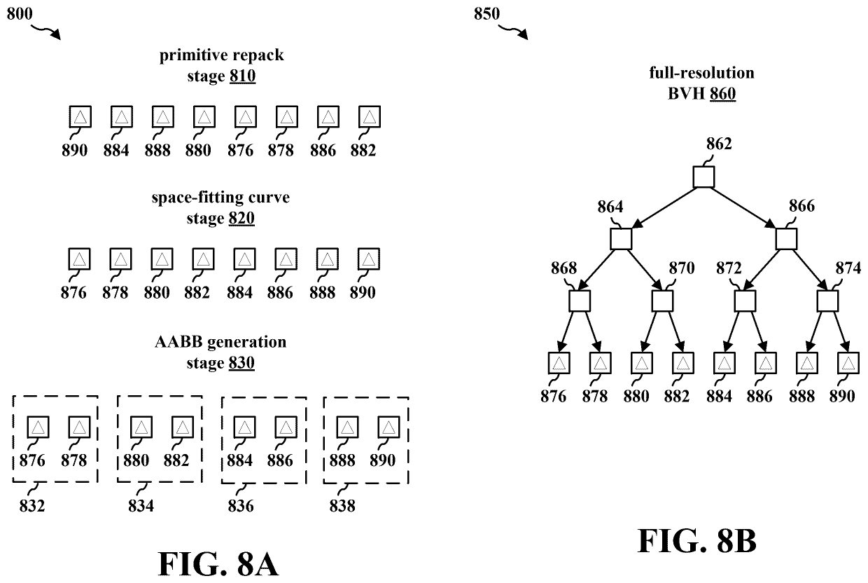

FIG. 8A is a diagram 800 of a series of stages that may be used to generate a full-resolution BVH in accordance with one or more techniques of this disclosure. At the primitive repack stage 810, a BVH building engine may repack a set of primitives as an array of primitives that may be inserted into a BVH. The primitive repack stage 810 may include a primitive 876, a primitive 878, a primitive 880, a primitive 882, a primitive 884, a primitive 886, a primitive 888, and a primitive 890. The BVH building engine may repack the set of primitives in any suitable order during the primitive repack stage 810.

At the space-fitting curve stage 820, a BVH building engine may sort the set of primitives in an array such that the primitives are adjacent to one another. In other words, each of the sorted primitives in the space-fitting curve stage 820 may be clustered such that the primitives are adjacent to the next-closest primitive. The BVH building engine may sort the primitives using any suitable sorting technique, for example based on a Morton space-filling curve.

At the AABB generation stage 830, a BVH building engine may build an AABB around each primitive such that the primitive lies within the AABB. The BVH building engine may tightly constrain the AABB around each primitive such that a border of the AABB aligns with a point of an edge of the corresponding primitive. In diagram 800, an AABB may also be built around pairs of primitives. For example, the AABB 832 may tightly constrain the primitive 876 and the primitive 878, the AABB 834 may tightly constrain the primitive 880 and the primitive 882, the AABB 836 may tightly constrain the primitive 884 and the primitive 886, and the AABB 838 may tightly constrain the primitive 888 and the primitive 890. The AABB generation stage may build further AABBs around pairs of AABBs until a single AABB is generated that includes all of the primitives included in the space-fitting curve stage 820.

FIG. 8B is a diagram 850 illustrating an example of a full-resolution BVH 860 generated using the series of stages in FIG. 8A in accordance with one or more techniques of this disclosure. The full-resolution BVH 860 may be a binary tree having primitive leaves sorted by the space-fitting curve stage 820 of FIG. 8A. The full-resolution BVH 860 may have an internal node 862, also known as the root internal node, an internal node 864 and an internal node 866, which may be children of the internal node 862, an internal node 868 and an internal node 870, which may be children of the internal node 864, a primitive 876 and a primitive 878, which may be leaves of the internal node 868, a primitive 880 and a primitive 882, which may be leaves of the internal node 870, an internal node 872 and an internal node 874, which may be children of the internal node 866, a primitive 884 and a primitive 886, which may be leaves of the internal node 872, and a primitive 888 and a primitive 890, which may be leaves of the internal node 874. Each of the internal nodes may be bounded by a corresponding AABB associated with the child leaves. For example, the internal node 868 may be associated with the AABB 832, the internal node 870 may be associated with the AABB 834, the internal node 872 may be associated with the AABB 836, and the internal node 874 may be associated with the AABB 838. Each parent internal node may be associated with an AABB that tightly constrains the associated child AABBs. A BVH traversal of the full-resolution BVH 860 may start at the internal node 862 to determine whether a ray intersects one of the primitives of the full-resolution BVH 860.

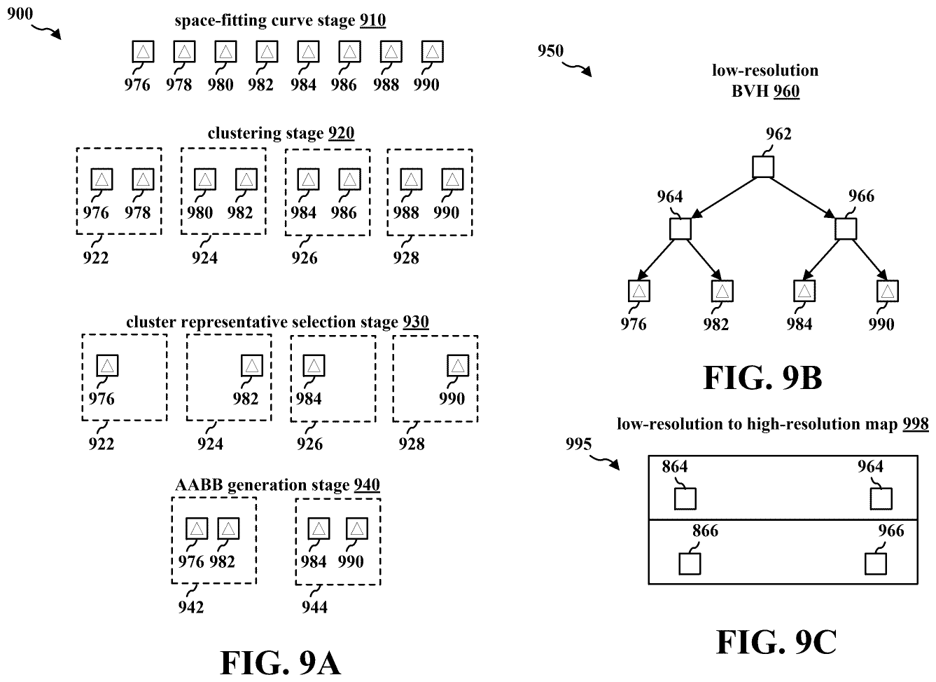

FIG. 9A is a diagram 900 of a series of stages that may be used to generate a full-resolution BVH in accordance with one or more techniques of this disclosure. At the space-fitting curve stage 910, a BVH building engine may sort a set of primitives in an array such that the primitives are adjacent to one another. In other words, each of the sorted primitives in the space-fitting curve stage 910 may be clustered such that the primitives are adjacent to the next-closest primitive. The BVH building engine may sort the primitives using any suitable sorting technique, for example based on a Morton space-filling curve.

At the clustering stage 920, a BVH building engine may cluster the primitives of the tree into N different strata. Each of the clusters may be clustered based on their sorted order in the space-fitting curve stage 910. In one aspect, at the clustering stage 920, the BVH building engine may cluster the cluster 922 based on the primitive 976 and the primitive 978, may cluster the cluster 924 based on the primitive 980 and the primitive 982, may cluster the cluster 926 based on the primitive 984 and the primitive 986, and may cluster the cluster 928 based on the primitive 988 and the primitive 990. While the cluster 922, the cluster 924, the cluster 926, and the cluster 928 may be clustered based on two adjacent primitives, the BVH building engine may build the clusters based on 2, 3, 4, 5, or more primitives in other aspects.

At the cluster representative selection stage 930, a BVH building engine may select a subset of representative primitives to represent each clustered primitives. For example, at the cluster representative selection stage 930, the BVH building engine may select the primitive 976 to represent the cluster 922, may select the primitive 982 to represent the cluster 924, may select the primitive 984 to represent the cluster 926, and may select the primitive 990 to represent the cluster 928. While the selected primitives may represent a cluster of two primitives, any subset of primitives may represent any number of other primitives greater than the subset in other aspects. In some aspects, the BVH building engine may select a representative primitive based on a largest diagonal. In other words, the representative primitive may have a larger diagonal than any other diagonal of the primitives in the cluster. This ensures that there is a larger likelihood of a hit if a ray traces the representative primitive as opposed to any other primitive in the corresponding cluster of primitives. In other words, as the set of representative primitives is constructed during clustering stage, a BVH building engine may select one representative primitive to be associated with a conservative candidate node. A cluster may be associated with a plurality of primitives (e.g., cluster 922 associated with primitive 976 and primitive 978) and from this set one may be selected to be the representative primitive (e.g., primitive 976 selected to represent the cluster 922 that includes both primitive 976 and primitive 978).

At the AABB generation stage 940, a BVH building engine may select a plurality of primitives as leaves for a conservative candidate node of a low-resolution BVH. For example, the BVH building engine may generate an AABB 942 that encompasses the primitive 976 and the primitive 982 from the cluster representative selection stage 930, and may generate an AABB 944 that encompasses the primitive 984 and the primitive 990 from the cluster representative selection stage 930. While the AABB generation stage 940 selects two primitives for an AABB, the BVH building engine may select any number of primitives for an AABB of a low-resolution BVH.

FIG. 9B is a diagram 950 illustrating an example of a low-resolution BVH 960 generated using the series of stages in FIG. 9A in accordance with one or more techniques of this disclosure. The low-resolution BVH 960 may be a binary tree having conservative candidate nodes generated by the AABBs of the AABB generation stage 940 of FIG. 9A. The low-resolution BVH 960 may have an internal node 962, also known as the root internal node, an internal node 964, which may have the children of the primitive 976 and the primitive 982, and an internal node 966, which may have the children of the primitive 984 and the primitive 990. Each of the internal nodes may be bounded by a corresponding AABB associated with the child leaves. For example, the internal node 964 may be associated with the AABB 942, and the internal node 966 may be associated with the AABB 944. Each parent internal node may be associated with an AABB that tightly constrains the associated child AABBs. A BVH traversal of the low-resolution BVH 960 may start at the internal node 962 to determine whether a ray intersects one of the primitives of the low-resolution BVH 960. A miss at one of the conservative candidate nodes 964 or 966, or at one of the primitive leaves, may not represent a true miss, and may trigger a traversal at a corresponding internal node of the corresponding full-resolution BVH.

FIG. 9C is a diagram 995 illustrating an example of a low-resolution to high-resolution map 998 for the low-resolution BVH 960 of FIG. 9B and the full-resolution BVH 860 of FIG. 8B in accordance with one or more techniques of this disclosure. The low-resolution to high-resolution map 998 may associate the conservative candidate node 964 with the internal node 864 of the full-resolution BVH 860 of FIG. 8B, and may associate the conservative candidate node 966 with the internal node 866 of the full-resolution BVH 860 of FIG. 8B.

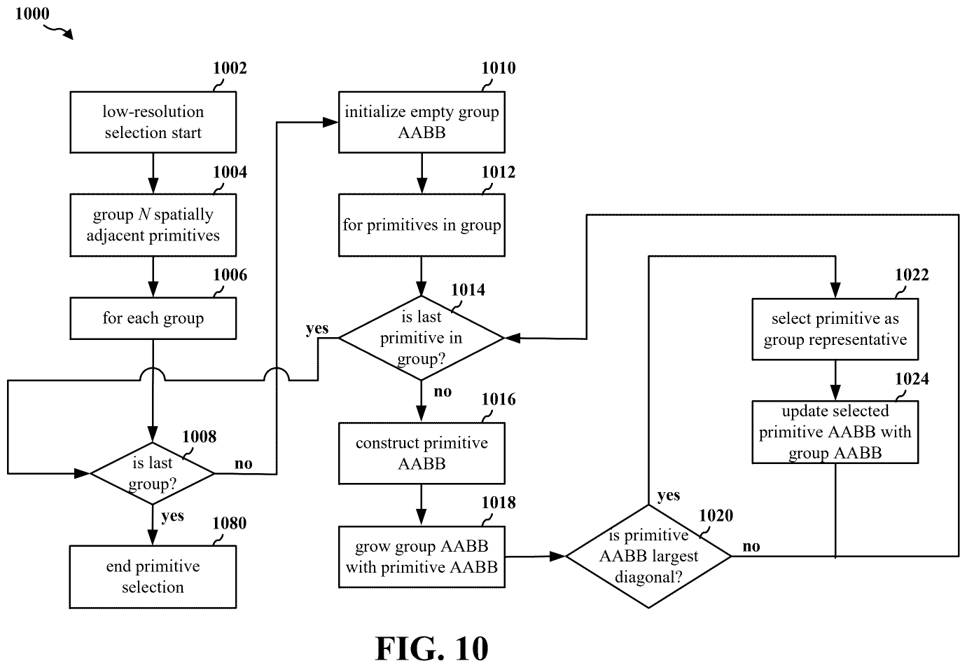

FIG. 10 is a diagram 1000 illustrating an example method of generating a low-resolution BVH in accordance with one or more techniques of this disclosure. At 1002, a BVH building engine may start a selection of representative primitives for a low-resolution BVH. For example, the BVH building engine may obtain a set of primitives that have been sorted via a space-fitting curve, may split the set of primitives into clusters of primitives, and may select representative primitives for each cluster of primitives. The BVH building engine may select a subset of primitives to represent the primitives of a primitive cluster, for example the cluster 922 or the cluster 924 in FIG. 9A. In some aspects, the BVH building engine may select one primitive from a cluster to represent the entire cluster. In some aspects, the BVH building engine may select a strict subset of primitives from a cluster to represent the entire cluster.

At 1004, the BVH building engine may group N spatially adjacent primitives with one another, where a subset of the primitives may be used as representative primitives for the primitive cluster. One cluster may have less than N spatially adjacent primitives. For example, a set of 1024 sorted adjacent primitives may be grouped into 205 clusters, where 204 clusters each have 5 primitives and the last cluster has 4 primitives. At 1006, the BVH building engine may iterate through each group of the primitive clusters to ensure that each primitive cluster iterates through 1008-1024. A cluster of primitives may be referred to as a group of primitives.

At 1008, the BVH building engine may determine if there are any more primitive clusters, or groups. If there are more groups, then the BVH building engine may, at 1010, initialize an AABB for an empty group that is associated with the present cluster of primitives. At 1012, the BVH building engine may iterate through each primitive of the primitive cluster. At 1014, the BVH building engine may determine if there are any more primitives in the current group. If there are more primitives, then the BVH engine may, at 1016, construct a primitive AABB associated with the current primitive. At 1018, the BVH building engine may grow, or increase the size of, the AABB to encompass the current primitive AABB. At 1020, the BVH building engine may determine if the current primitive AABB has the largest diagonal of the current group. If yes, then at 1022, the BVH building engine may select the current primitive as the representative primitive of the primitive cluster. At 1024, the BVH building engine may update the selected representative primitive AABB with the group AABB, ensuring that any intersect of an AABB of the representative primitive encompasses the AABB of the entire group. Otherwise, the BVH building engine may advance to 1014 to analyze the next primitive of the group. If, at 1014, the BVH building engine runs out of primitives to analyze (e.g., the BVH building engine hits a null), then the BVH building engine may advance to 1008 to analyze the next group, or primitive cluster. If, at 1008, the BVH building engine runs out of groups to analyze (e.g., the BVH building engine hits a null), then the BVH building engine may advance to 1080.

At 1080, the BVH building engine may end the primitive selection and may output the generated low-resolution BVH to a BVH traversal engine, for example the BVH traversal engine 199 of FIG. 1. In some aspects, the BVH building engine may also output a map that correlates representative primitives, or associated conservative candidate nodes of the low-resolution BVH, to nodes of the associated full-resolution BVH that includes the full set of primitives. As used herein, outputting an indication may comprise transmitting, sending, providing, and/or storing the indication.

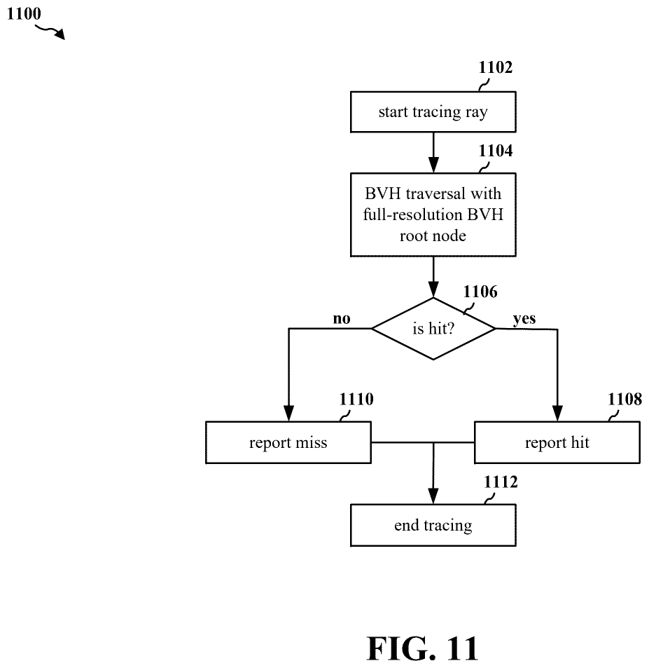

FIG. 11 is a diagram 1100 illustrating an example method of traversing a full-resolution BVH in accordance with one or more techniques of this disclosure. At 1102, a BVH traversal engine may start tracing a ray for a full-resolution BVH. At 1104, the BVH traversal engine may perform BVH traversal with a full-resolution BVH root node. If the ray intersects the AABB associated with the root node, then the BVH traversal engine may advance to a corresponding child (e.g., an internal node or a primitive leaf) of the full-resolution BVH and continue performing comparisons until it reaches a primitive leaf. If, at 1106, a comparison reveals that the ray intersects an AABB associated with a leaf, then the BVH traversal engine may report a hit at 1108 and end ray tracing at 1112. If the ray does not intersect the AABB associated with any node of the full-resolution BVH (e.g., the root node, an internal node, a leaf), then the BVH internal engine may advance to 1110, whereupon the BVH traversal engine reports a miss and ends tracing at 1112.

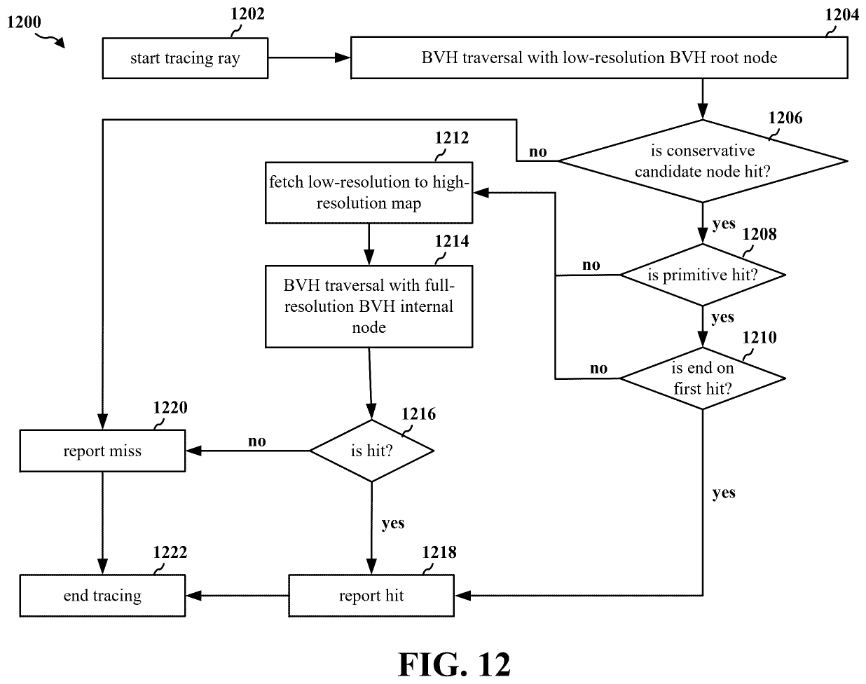

FIG. 12 is a diagram 1200 illustrating an example method of traversing a low-resolution BVH in accordance with one or more techniques of this disclosure. At 1202, a BVH traversal engine may start tracing a ray for a BVH. At 1204, the BVH traversal engine may perform BVH traversal with a low-resolution BVH root node. If the ray intersects of the AABB associated with the root node, then the BVH traversal engine may advance to a corresponding child (e.g., an internal node or a conservative candidate node) of the low-resolution BVH and continue performing comparisons. If, at 1206, the ray does not intersect the AABB associated with the node of the low-resolution BVH, then at 1220, the BVH traversal engine may report a miss and may end ray tracing at 1222. If, at 1206, a comparison reveals that the ray intersects an AABB associated with a conservative candidate node, then the BVH traversal engine may advance to 1208. At 1208, the BVH traversal engine may determine if a primitive leaf is hit. If, at 1208, the BVH traversal engine determines that a primitive leaf is hit, then the BVH traversal engine may, at 1210, determine if the ray tracing is to end on a first hit (whether the BVH traversal engine is to determine if the ray hits any primitive in the BVH, or to determine any and all primitives that the ray hits). If the ray tracing is to end on a first hit, then at 1218, the BVH traversal engine may report a hit for the primitive and may end ray tracing at 1222. If a primitive is not hit, or if the ray tracing is not to end on a first hit, then at 1212, the BVH traversal engine may fetch the low-resolution to high-resolution map to determine which internal node of the full-resolution BVH corresponds with the conservative candidate internal node associated with the missed traversal. At 1214, the BVH traversal engine may perform BVH traversal with the full-resolution BVH. The BVH traversal engine may start its BVH traversal with the full-resolution BVH at the internal node of the full-resolution BVH that corresponds with the conservative candidate internal node associated with the missed traversal (e.g., based on the low-resolution to high-resolution map), and at 1216, may report whether or not the ray hits a primitive leaf of the full-resolution BVH internal node.

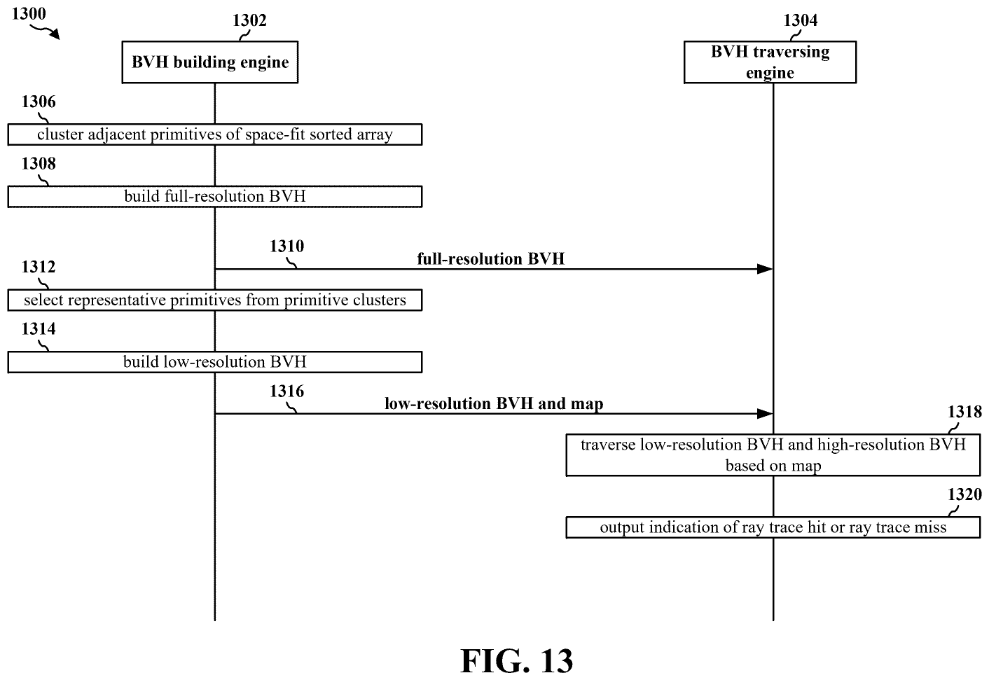

FIG. 13 is a call flow diagram 1300 illustrating example communications between a BVH-building component and a BVH-traversing component in accordance with one or more techniques of this disclosure. A BVH building engine 1302 may be configured to build a BVH, for example a full-resolution BVH and/or a corresponding low-resolution BVH. The BVH building engine 1302 may also be configured to build a corresponding low-resolution to high-resolution map that correlates conservative candidate nodes of the low-resolution BVH with internal nodes of the high-resolution BVH. A BVH traversing engine 1304 may be configured to traverse a low-resolution BVH. At 1306, the BVH building engine 1302 may cluster adjacent primitives of a space-fit sorted array. At 1308, the BVH building engine 1302 may build a full-resolution BVH based on the space-fit sorted array generated at 1306. The BVH building engine 1302 may transmit an indication 1310 of the full-resolution BVH generated at 1308 to the BVH traversing engine 1304. At 1312, the BVH building engine 1302 may select a set of representative primitives from primitive clusters of the primitive clusters clustered at 1306. At 1314, the BVH building engine 1302 may build a low-resolution BVH based on the representative primitives selected at 1312. The BVH building engine 1302 may transmit an indication 1316 of the low-resolution BVH and corresponding map to the BVH traversing engine 1304. At 1318, the BVH traversing engine 1304 may traverse the low-resolution BVH and the high-resolution BVH based on the map transmitted from the BVH building engine 1302. In some aspects, the BVH traversing engine 1304 may use the low-resolution BVH to determine whether a ray intersects a leaf of a BVH. In some aspects, the BVH traversing engine 1304 may correlate a missed conservative candidate node of the low-resolution BVH with the full-resolution BVH using the map. At 1320, the BVH traversing engine 1304 may output an indication of a ray trace hit or a ray trace miss based on the traversal at 1318.

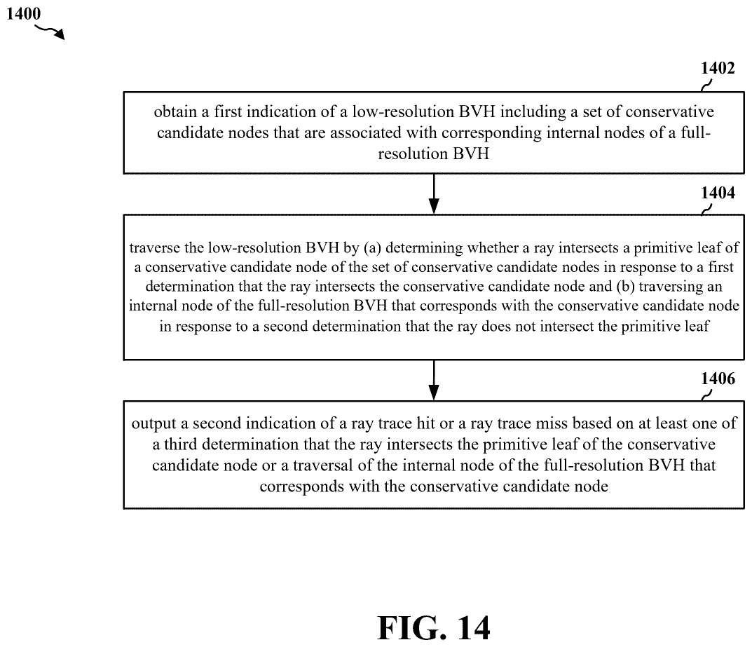

FIG. 14 is a flowchart 1400 of an example method of graphics processing in accordance with one or more techniques of this disclosure. The method may be performed by an apparatus, such as an apparatus for graphics processing, a GPU, a CPU, a compiler, the device 104, the processing unit 120, a wireless communication device, and the like, as used in connection with the aspects of FIGS. 1-3, FIG. 4A, FIG. 4B, FIG. 5, FIG. 6A, FIG. 6B, FIG. 7A, FIG. 7B, FIG. 8A, FIG. 8B, FIG. 9A, FIG. 9B, FIG. 9C, and FIGS. 10-13. The method may be associated with various advantages, such as efficiently traversing a low-resolution BVH. In an example, the method may be performed by the BVH traversing engine 199.

At 1402, the apparatus may obtain a first indication of a low-resolution BVH including a set of conservative candidate nodes that are associated with corresponding internal nodes of a full-resolution BVH. For example, 1402 may be performed by the BVH traversing engine 1304 in FIG. 13, which may receive an indication 1316 of a low-resolution BVH and a corresponding map from the BVH building engine 1302. The indication 1316 of the low-resolution BVH and the corresponding map may include an indication of a low-resolution BVH that includes a set of conservative candidate nodes that are associated with corresponding internal nodes of a full-resolution BVH, such as the full-resolution BVH generated at 1308 associated with the indication 1310. Moreover, 1402 may be performed by the BVH traversing engine 199 in FIG. 1.

At 1404, the apparatus may traverse the low-resolution BVH by (a) determining whether a ray intersects a primitive leaf of a conservative candidate node of the set of conservative candidate nodes in response to a first determination that the ray intersects the conservative candidate node and (b) traversing an internal node of the full-resolution BVH that corresponds with the conservative candidate node in response to a second determination that the ray does not intersect the primitive leaf. For example, 1404 may be performed by the BVH traversing engine 1304 in FIG. 13, which may traverse the low-resolution BVH by (a) determining whether a ray intersects a primitive leaf of a conservative candidate node of the set of conservative candidate nodes in response to a first determination that the ray intersects the conservative candidate node and (b) traversing an internal node of the full-resolution BVH that corresponds with the conservative candidate node in response to a second determination that the ray does not intersect the primitive leaf. Moreover, 1404 may be performed by the BVH traversing engine 199 in FIG. 1.

At 1406, the apparatus may output a second indication of a ray trace hit or a ray trace miss based on at least one of a third determination that the ray intersects the primitive leaf of the conservative candidate node or a traversal of the internal node of the full-resolution BVH that corresponds with the conservative candidate node. For example, 1406 may be performed by the BVH traversing engine 1304 in FIG. 13, which may, at 1320, output a second indication of a ray trace hit or a ray trace miss based on at least one of a third determination that the ray intersects the primitive leaf of the conservative candidate node or a traversal of the internal node of the full-resolution BVH that corresponds with the conservative candidate node. Moreover, 1406 may be performed by the BVH traversing engine 199 in FIG. 1.

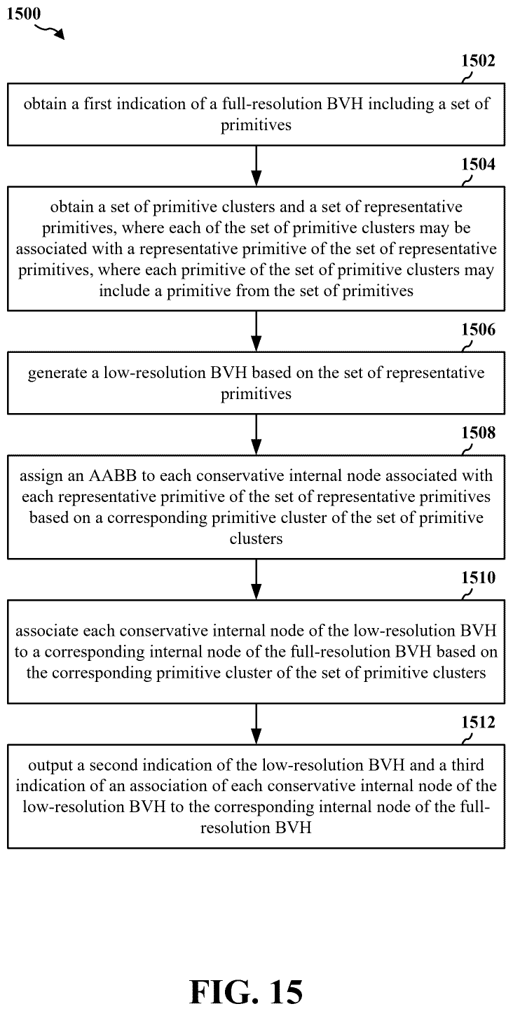

FIG. 15 is a flowchart 1500 of an example method of graphics processing in accordance with one or more techniques of this disclosure. The method may be performed by an apparatus, such as an apparatus for graphics processing, a GPU, a CPU, a compiler, the device 104, the processing unit 120, a wireless communication device, and the like, as used in connection with the aspects of FIGS. 1-3, FIG. 4A, FIG. 4B, FIG. 5, FIG. 6A, FIG. 6B, FIG. 7A, FIG. 7B, FIG. 8A, FIG. 8B, FIG. 9A, FIG. 9B, FIG. 9C, and FIGS. 10-13. The method may be associated with various advantages, such as generating a low-resolution BVH. In an example, the method may be performed by the BVH building engine 198.

At 1502, the apparatus may obtain a first indication of a full-resolution BVH including a set of primitives. For example, 1502 may be performed by the BVH building engine 1302 in FIG. 13, which may, at 1308, obtain a first indication of a full-resolution BVH including a set of primitives. Moreover, 1502 may be performed by the BVH building engine 198 in FIG. 1.

At 1504, the apparatus may obtain a set of primitive clusters and a set of representative primitives. Each of the set of primitive clusters may be associated with a representative primitive of the set of representative primitives. Each primitive of the set of primitive clusters may include a primitive from the set of primitives. For example, 1504 may be performed by the BVH building engine 1302 in FIG. 13, which may, at 1312, obtain a set of primitive clusters and a set of representative primitives. Each of the set of primitive clusters may be associated with a representative primitive of the set of representative primitives. Each primitive of the set of primitive clusters may include a primitive from the set of primitives. Moreover, 1504 may be performed by the BVH building engine 198 in FIG. 1.

At 1506, the apparatus may generate a low-resolution BVH based on the set of representative primitives. For example, 1506 may be performed by the BVH building engine 1302 in FIG. 13, which may, at 1314, generate a low-resolution BVH based on the set of representative primitives. Moreover, 1506 may be performed by the BVH building engine 198 in FIG. 1.

At 1508, the apparatus may assign an AABB to each conservative internal node associated with each representative primitive of the set of representative primitives based on a corresponding primitive cluster of the set of primitive clusters. For example, 1508 may be performed by the BVH building engine 1302 in FIG. 13, which may, at 1314, assign an AABB to each conservative internal node associated with each representative primitive of the set of representative primitives based on a corresponding primitive cluster of the set of primitive clusters. Moreover, 1508 may be performed by the BVH building engine 198 in FIG. 1.

At 1510, the apparatus may associate each conservative internal node of the low-resolution BVH to a corresponding internal node of the full-resolution BVH based on the corresponding primitive cluster of the set of primitive clusters. For example, 1510 may be performed by the BVH building engine 1302 in FIG. 13, which may, at 1314, associate each conservative internal node of the low-resolution BVH to a corresponding internal node of the full-resolution BVH based on the corresponding primitive cluster of the set of primitive clusters. Moreover, 1510 may be performed by the BVH building engine 198 in FIG. 1.

At 1512, the apparatus may output a second indication of the low-resolution BVH and a third indication of an association of each conservative internal node of the low-resolution BVH to the corresponding internal node of the full-resolution BVH. For example, 1512 may be performed by the BVH building engine 1302 in FIG. 13, which may transmit an indication 1316 of the low-resolution BVH and corresponding map to the BVH traversing engine 1304. The indication 1316 of the low-resolution BVH and corresponding map may include a second indication of the low-resolution BVH and a third indication of an association of each conservative internal node of the low-resolution BVH to the corresponding internal node of the full-resolution BVH. Moreover, 1512 may be performed by the BVH building engine 198 in FIG. 1.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for obtaining a first indication of a low-resolution BVH comprising a set of conservative candidate nodes that are associated with corresponding internal nodes of a full-resolution BVH. The apparatus may include means for traversing the low-resolution BVH by (a) determining whether a ray intersects a primitive leaf of a conservative candidate node of the set of conservative candidate nodes in response to a first determination that the ray intersects the conservative candidate node, and (b) traversing an internal node of the full-resolution BVH that corresponds with the conservative candidate node in response to a second determination that the ray does not intersect the primitive leaf. The apparatus may include means for outputting a second indication of a ray trace hit or a ray trace miss based on at least one of a third determination that the ray intersects the primitive leaf of the conservative candidate node or a traversal of the internal node of the full-resolution BVH that corresponds with the conservative candidate node. The conservative candidate node may include a first set of primitive leaves and may be associated with an AABB that bounds a second set of primitive leaves. The first set of primitive leaves may be a subset of the second set of primitive leaves. The internal node of the full-resolution BVH that corresponds with the conservative candidate node may include a third set of child primitive leaves including the second set of primitive leaves. The apparatus may include means for traversing the low-resolution BVH by at least one of: traversing a second internal node of the low-resolution BVH. The apparatus may include means for traversing the conservative candidate node of the set of conservative candidate nodes in response to a fourth determination that the ray intersects the second internal node of the low-resolution BVH. The apparatus may include means for outputting a third indication of a second ray trace hit or a second ray trace miss based on at least one of a fifth determination that the ray does not intersect the second internal node of the low-resolution BVH, or a sixth determination that the ray does not intersect the conservative candidate node. The apparatus may include means for determining whether a second traversal of the ray intersects on a first hit; and traversing the internal node of the full-resolution BVH that corresponds with the conservative candidate node in response to a fourth determination that the traversal of the ray does not end on the first hit where the ray intersects the primitive leaf. A first ray trace miss of any of the set of conservative candidate nodes of the low-resolution BVH may correspond with a second ray trace miss of every internal node of the full-resolution BVH. A first ray trace miss of any internal node of the low-resolution BVH may correspond with a second ray trace miss of every internal node of the full-resolution BVH. The internal node of the full-resolution BVH that corresponds with the conservative candidate node may include a set of child primitives that are constrained by an AABB of the conservative candidate node.

The apparatus may include means for obtaining a first indication of a full-resolution BVH comprising a set of primitives. The apparatus may include means for obtaining a set of primitive clusters and a set of representative primitives. Each of the set of primitive clusters may be associated with a representative primitive of the set of representative primitives. Each primitive of the set of primitive clusters may be a primitive from the set of primitives. The apparatus may include means for generating a low-resolution BVH based on the set of representative primitives. The apparatus may include means for assigning an axis-aligned bounding box (AABB) to each conservative internal node associated with each representative primitive of the set of representative primitives based on a corresponding primitive cluster of the set of primitive clusters. The apparatus may include means for associating each conservative internal node of the low-resolution BVH to a corresponding internal node of the full-resolution BVH based on the corresponding primitive cluster of the set of primitive clusters. The apparatus may include means for outputting a second indication of the low-resolution BVH and a third indication of an association of each conservative internal node of the low-resolution BVH to the corresponding internal node of the full-resolution BVH. The apparatus may include means for assigning the AABB to each conservative internal node associated with the representative primitive based on the corresponding primitive cluster of the set of primitive clusters by assigning the AABB to each conservative internal node such that the assigned AABB encompasses each primitive of the corresponding primitive cluster. The apparatus may include means for obtaining a fourth indication of a space-fit sorted array of the set of primitives; clustering adjacent primitives of the space-fit sorted array into the set of primitive clusters; and selecting the representative primitive for each primitive cluster of the set of primitive clusters. The apparatus may include means for obtaining the second indication of the space-fit sorted array of the set of primitives by sorting the set of primitives based on a Morton space-filling curve. The apparatus may include means for selecting the representative primitive for each primitive cluster of the set of primitive clusters by selecting the representative primitive based on a largest comparative diagonal size. The corresponding internal node of the full-resolution BVH that corresponds with each conservative candidate node may include a set of child primitives that are constrained by an AABB of the conservative candidate node. The third indication of the association of each conservative internal node of the low-resolution BVH to the corresponding internal node of the full-resolution BVH may include an index comprising a first set of identifiers for a set of conservative internal nodes of the low-resolution BVH and a second set of identifiers for a set of corresponding internal nodes of the full-resolution BVH.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.
Aspect 1 is a method of graphics processing, comprising: obtaining a first indication of a low-resolution bounding volume hierarchy (BVH) comprising a set of conservative candidate nodes that are associated with corresponding internal nodes of a full-resolution BVH; traversing the low-resolution BVH by: determining whether a ray intersects a primitive leaf of a conservative candidate node of the set of conservative candidate nodes in response to a first determination that the ray intersects the conservative candidate node; and traversing an internal node of the full-resolution BVH that corresponds with the conservative candidate node in response to a second determination that the ray does not intersect the primitive leaf; and outputting a second indication of a ray trace hit or a ray trace miss based on at least one of a third determination that the ray intersects the primitive leaf of the conservative candidate node or a traversal of the internal node of the full-resolution BVH that corresponds with the conservative candidate node.
Aspect 2 is the method of aspect 1, wherein the conservative candidate node comprises a first set of primitive leaves and is associated with an axis-aligned bounding box (AABB) that bounds a second set of primitive leaves, wherein the first set of primitive leaves is a subset of the second set of primitive leaves, wherein the internal node of the full-resolution BVH that corresponds with the conservative candidate node comprises a third set of child primitive leaves comprising the second set of primitive leaves.
Aspect 3 is the method of either of aspects 1 or 2, further comprising: traversing the low-resolution BVH by at least one of: traversing a second internal node of the low-resolution BVH; or traversing the conservative candidate node of the set of conservative candidate nodes in response to a fourth determination that the ray intersects the second internal node of the low-resolution BVH; and outputting a third indication of a second ray trace hit or a second ray trace miss based on at least one of a fifth determination that the ray does not intersect the second internal node of the low-resolution BVH, or a sixth determination that the ray does not intersect the conservative candidate node.
Aspect 4 is the method of any of aspects 1 to 3, further comprising: determining whether a second traversal of the ray intersects on a first hit; and traversing the internal node of the full-resolution BVH that corresponds with the conservative candidate node in response to a fourth determination that the traversal of the ray does not end on the first hit wherein the ray intersects the primitive leaf.
Aspect 5 is the method of any of aspects 1 to 4, wherein a first ray trace miss of any of the set of conservative candidate nodes of the low-resolution BVH corresponds with a second ray trace miss of every internal node of the full-resolution BVH.
Aspect 6 is the method of any of aspects 1 to 5, wherein a first ray trace miss of any internal node of the low-resolution BVH corresponds with a second ray trace miss of every internal node of the full-resolution BVH.
Aspect 7 is the method of any of aspects 1 to 6, wherein the internal node of the full-resolution BVH that corresponds with the conservative candidate node comprises a set of child primitives that are constrained by an axis-aligned bounding box (AABB) of the conservative candidate node.
Aspect 8 is a method of graphics processing, comprising: obtaining a first indication of a full-resolution bounding volume hierarchy (BVH) comprising a set of primitives; obtaining a set of primitive clusters and a set of representative primitives, wherein each of the set of primitive clusters is associated with a representative primitive of the set of representative primitives, wherein each primitive of the set of primitive clusters comprises a primitive from the set of primitives; generating a low-resolution BVH based on the set of representative primitives; assigning an axis-aligned bounding box (AABB) to each conservative internal node associated with each representative primitive of the set of representative primitives based on a corresponding primitive cluster of the set of primitive clusters; associating each conservative internal node of the low-resolution BVH to a corresponding internal node of the full-resolution BVH based on the corresponding primitive cluster of the set of primitive clusters; and outputting a second indication of the low-resolution BVH and a third indication of an association of each conservative internal node of the low-resolution BVH to the corresponding internal node of the full-resolution BVH.
Aspect 9 is the method of aspect 8, wherein assigning the AABB to each conservative internal node associated with the representative primitive based on the corresponding primitive cluster of the set of primitive clusters comprises: assigning the AABB to each conservative internal node such that the assigned AABB encompasses each primitive of the corresponding primitive cluster.
Aspect 10 is the method of either of aspects 8 or 9, further comprising: obtaining a fourth indication of a space-fit sorted array of the set of primitives; clustering adjacent primitives of the space-fit sorted array into the set of primitive clusters; and selecting the representative primitive for each primitive cluster of the set of primitive clusters.
Aspect 11 is the method of aspect 10, wherein obtaining the second indication of the space-fit sorted array of the set of primitives comprises: sorting the set of primitives based on a Morton space-filling curve.
Aspect 12 is the method of either of aspects 10 or 11, wherein selecting the representative primitive for each primitive cluster of the set of primitive clusters comprises: selecting the representative primitive based on a largest comparative diagonal size.
Aspect 13 is the method of any of aspects 8 to 12, wherein the corresponding internal node of the full-resolution BVH that corresponds with each conservative candidate node comprises a set of child primitives that are constrained by an AABB of the conservative candidate node.
Aspect 14 is the method of any of aspects 8 to 13, wherein the third indication of the association of each conservative internal node of the low-resolution BVH to the corresponding internal node of the full-resolution BVH comprises an index comprising a first set of identifiers for a set of conservative internal nodes of the low-resolution BVH and a second set of identifiers for a set of corresponding internal nodes of the full-resolution BVH.
Aspect 15 is an apparatus for graphics processing including at least one processor coupled to a memory and configured to implement a method as in any of aspects 1-14.
Aspect 16 may be combined with aspect 15 and includes that the apparatus is a wireless communication device.
Aspect 17 is an apparatus for graphics processing including means for implementing a method as in any of aspects 1-14.
Aspect 18 is a computer-readable medium storing computer executable code, the code when executed by at least one processor causes the at least one processor to implement a method as in any of aspects 1-14.

Various aspects have been described herein. These and other aspects are within the scope of the following claims.

What is claimed is:

1. An apparatus for graphics processing, comprising:
a memory; and
a processor coupled to the memory and, based at least in part on information stored in the memory, the processor is configured to:
obtain a first indication of a low-resolution bounding volume hierarchy (BVH) comprising a set of conservative candidate nodes that are associated with corresponding internal nodes of a full-resolution BVH;
traverse the low-resolution BVH by:
determining whether a ray intersects a primitive leaf of a conservative candidate node of the set of conservative candidate nodes in response to a first determination that the ray intersects the conservative candidate node; and
traversing an internal node of the full-resolution BVH that corresponds with the conservative candidate node in response to a second determination that the ray does not intersect the primitive leaf; and
output a second indication of a ray trace hit or a ray trace miss based on at least one of a third determination that the ray intersects the primitive leaf of the conservative candidate node or a traversal of the internal node of the full-resolution BVH that corresponds with the conservative candidate node.

2. The apparatus of claim 1, wherein the conservative candidate node comprises a first set of primitive leaves and is associated with an axis-aligned bounding box (AABB) that bounds a second set of primitive leaves, wherein the first set of primitive leaves is a subset of the second set of primitive leaves, wherein the internal node of the full-resolution BVH that corresponds with the conservative candidate node comprises a third set of child primitive leaves comprising the second set of primitive leaves.

3. The apparatus of claim 1, wherein the processor is further configured to:
traverse the low-resolution BVH by at least one of:
traversing a second internal node of the low-resolution BVH; or
traversing the conservative candidate node of the set of conservative candidate nodes in response to a fourth determination that the ray intersects the second internal node of the low-resolution BVH; and
output a third indication of a second ray trace hit or a second ray trace miss based on at least one of a fifth determination that the ray does not intersect the second internal node of the low-resolution BVH, or a sixth determination that the ray does not intersect the conservative candidate node.

4. The apparatus of claim 1, wherein the processor is further configured to:
determine whether a second traversal of the ray intersects on a first hit; and
traverse the internal node of the full-resolution BVH that corresponds with the conservative candidate node in response to a fourth determination that the traversal of the ray does not end on the first hit wherein the ray intersects the primitive leaf.

5. The apparatus of claim 1, wherein a first ray trace miss of any of the set of conservative candidate nodes of the low-resolution BVH corresponds with a second ray trace miss of every internal node of the full-resolution BVH.

6. The apparatus of claim 1, wherein a first ray trace miss of any internal node of the low-resolution BVH corresponds with a second ray trace miss of every internal node of the full-resolution BVH.

7. The apparatus of claim 1, wherein the internal node of the full-resolution BVH that corresponds with the conservative candidate node comprises a set of child primitives that are constrained by an axis-aligned bounding box (AABB) of the conservative candidate node.

8. An apparatus for graphics processing, comprising:
a memory; and
a processor coupled to the memory and, based at least in part on information stored in the memory, the processor is configured to:
obtain a first indication of a full-resolution bounding volume hierarchy (BVH) comprising a set of primitives;
obtain a set of primitive clusters and a set of representative primitives, wherein each of the set of primitive clusters is associated with a representative primitive of the set of representative primitives, wherein each primitive of the set of primitive clusters comprises a primitive from the set of primitives;
generate a low-resolution BVH based on the set of representative primitives;
assign an axis-aligned bounding box (AABB) to each conservative internal node associated with each representative primitive of the set of representative primitives based on a corresponding primitive cluster of the set of primitive clusters;
associate each conservative internal node of the low-resolution BVH to a corresponding internal node of the full-resolution BVH based on the corresponding primitive cluster of the set of primitive clusters; and
output a second indication of the low-resolution BVH and a third indication of an association of each conservative internal node of the low-resolution BVH to the corresponding internal node of the full-resolution BVH.

9. The apparatus of claim 8, wherein, to assign the AABB to each conservative internal node associated with the representative primitive based on the corresponding primitive cluster of the set of primitive clusters, the processor is configured to:
assign the AABB to each conservative internal node such that the assigned AABB encompasses each primitive of the corresponding primitive cluster.

10. The apparatus of claim 8, wherein, to obtain the set of primitive clusters and the set of representative primitives, the processor is configured to:
obtain a fourth indication of a space-fit sorted array of the set of primitives;
cluster adjacent primitives of the space-fit sorted array into the set of primitive clusters; and
select the representative primitive for each primitive cluster of the set of primitive clusters.

11. The apparatus of claim 10, wherein, to obtain the second indication of the space-fit sorted array of the set of primitives, the processor is configured to:
sort the set of primitives based on a Morton space-filling curve.

12. The apparatus of claim 10, wherein, to select the representative primitive for each primitive cluster of the set of primitive clusters, the processor is configured to:
select the representative primitive based on a largest comparative diagonal size.

13. The apparatus of claim 8, wherein the corresponding internal node of the full-resolution BVH that corresponds with each conservative candidate node comprises a set of child primitives that are constrained by an AABB of the conservative candidate node.

14. The apparatus of claim 8, wherein the third indication of the association of each conservative internal node of the low-resolution BVH to the corresponding internal node of the full-resolution BVH comprises an index comprising a first set of identifiers for a set of conservative internal nodes of the low-resolution BVH and a second set of identifiers for a set of corresponding internal nodes of the full-resolution BVH.

15. A method of graphics processing, comprising:
obtaining a first indication of a low-resolution bounding volume hierarchy (BVH) comprising a set of conservative candidate nodes that are associated with corresponding internal nodes of a full-resolution BVH;
traversing the low-resolution BVH by:
determining whether a ray intersects a primitive leaf of a conservative candidate node of the set of conservative candidate nodes in response to a first determination that the ray intersects the conservative candidate node; and
traversing an internal node of the full-resolution BVH that corresponds with the conservative candidate node in response to a second determination that the ray does not intersect the primitive leaf; and
outputting a second indication of a ray trace hit or a ray trace miss based on at least one of a third determination that the ray intersects the primitive leaf of the conservative candidate node or a traversal of the internal node of the full-resolution BVH that corresponds with the conservative candidate node.

16. The method of claim 15, wherein the conservative candidate node comprises a first set of primitive leaves and is associated with an axis-aligned bounding box (AABB) that bounds a second set of primitive leaves, wherein the first set of primitive leaves is a subset of the second set of primitive leaves, wherein the internal node of the full-resolution BVH that corresponds with the conservative candidate node comprises a third set of child primitive leaves comprising the second set of primitive leaves.

17. The method of claim 15, further comprising:
traversing the low-resolution BVH by at least one of:
traversing a second internal node of the low-resolution BVH; or
traversing the conservative candidate node of the set of conservative candidate nodes in response to a fourth determination that the ray intersects the second internal node of the low-resolution BVH; and
outputting a third indication of a second ray trace hit or a second ray trace miss based on at least one of a fifth determination that the ray does not intersect the second internal node of the low-resolution BVH, or a sixth determination that the ray does not intersect the conservative candidate node.

18. The method of claim 15, further comprising:
determining whether a second traversal of the ray intersects on a first hit; and
traversing the internal node of the full-resolution BVH that corresponds with the conservative candidate node in response to a fourth determination that the traversal of the ray does not end on the first hit wherein the ray intersects the primitive leaf.

19. The method of claim 15, wherein a first ray trace miss of any of the set of conservative candidate nodes of the low-resolution BVH corresponds with a second ray trace miss of every internal node of the full-resolution BVH.

20. The method of claim 15, wherein a first ray trace miss of any internal node of the low-resolution BVH corresponds with a second ray trace miss of every internal node of the full-resolution BVH.
